(19) United States
(12) Patent Application Publication
(10) Pub. No.: US 2020/0282662 A1
(43) Pub. Date: Sep. 10, 2020

(54) METHOD OF SEALING AN AIRTIGHT BLADDER FOR A KITE AND AN AIRTIGHT BLADDER FOR A KITE

(71) Applicant: OCEAN RODEO SPORTS INC., Victoria (CA)

(72) Inventor: Richard Kerr MYERSCOUGH, Victoria (CA)

(21) Appl. No.: 16/810,290

(22) Filed: Mar. 5, 2020

Related U.S. Application Data
(60) Provisional application No. 62/815,796, filed on Mar. 8, 2019.

(51) Int. Cl. B29C 65/00; B29C 65/50; B29C 65/02; B64C 31/06

(52) U.S. Cl. CPC B29C 66/1122; B29C 65/50; B29L 2022/025; B64C 31/06; B29C 65/02

(57) ABSTRACT

An airtight bladder for kites and method of sealing an airtight bladder for kites. The bladder body has longitudinal edges sealed with a lap seam and ends sealed by a combination of deforming bladder material and applying an end seam. The deforming of the bladder materials is done by folding, rolling, accordion folding, knotting, or twisting the ends. The deforming of the bladder material in this matter shelters and protects the end seals.

### FIELD

The present invention relates to improved seam construction and finishing techniques for air tight bladders used in inflatable kite frames and more particularly Supported Leading Edge (SLE) Kites.

### BACKGROUND

A pressurized air frame is critical to the function of air inflatable air frame kites, also known as “Supported Leading Edge” (SLE) Kites. SLE Kites will not fly as designed unless inflated to a pressure of between 4 and 12 psi. It is becoming known that a more rigid air frame on SLE Kites can have desirable improvements in turn response input and stability.

The bladders used to support these air frames are most commonly made with thin monolithic membranes or films such as Polyurethane (PU), Polyethylene Terephthalate (PETE or PET), High-Density Polyethylene (HDPE), Polyvinyl Chloride (PVC), Low-Density Polyethylene (LDPE), Polypropylene (PP), Polystyrene. In most cases it is desirable to use the lightest membrane possible to reduce kite weight and improve performance while minimizing failures caused by the longitudinal air tight seams and closing end air tight seams.

Typically an inflatable SLE kite bladder is made with welded plain seams on all perimeters edges of the bladder to achieve the desired air holding requirement. This process however has limitations with thinner films of 70 microns or less, as welded plain seams are typically the failure point in crashes or in heavy use of SLE kites.

### SUMMARY

According to one aspect, there is provided a method of sealing an airtight bladder for kites. The method involves sealing longitudinal edges of an airtight bladder with a lap seam. The method then involves sealing ends of the bladder by both deforming bladder material and applying an end seam.

According to another aspect there is provided an airtight bladder for kites. The bladder includes a body having longitudinal edges sealed with a lap seam and ends sealed by a combination of deforming bladder material and applying an end seam.

As will hereinafter be described, laps seams cannot readily be used to seal the ends of the bladder body. However, it is the ends of the bladder body that are most prone to failure. This problem has been addressed by a combination of deforming the bladder material and applying an end seam.

After experimentation, it was determined that there are a number of different ways of deforming the bladder material to protect the end seal. There will hereinafter be described various deformations of the bladder material, which include folding, rolling, accordion folding, knotting, or twisting the ends.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a perspective view of an SLE kite.

FIG. 2 is a perspective view of an inflatable support structure of the SLE kite illustrated in FIG. 1.

FIG. 3 is a detailed perspective view of a strut for the inflatable support structure of the SLE kite illustrated in FIG. 2.

FIG. 4 is a top plan view of a bladder for the strut of FIG. 3, laid flat.

FIG. 5 is a side elevation view of the bladder for the strut of FIG. 3.

FIG. 6 is a section view of the bladder taken along section lines A-A of FIG. 5.

FIG. 7 is a side elevation view, in section, of the bladder of FIG. 5, showing a step in constructing a first embodiment of bladder having an end of a bladder 10 finished using a spacer.

FIG. 7A is a top plan view FIG. 7.

FIG. 8 is a side elevation view, in section, of the bladder of FIG. 7 showing a folding step in constructing the first embodiment of bladder.

FIG. 8A is a top plan view FIG. 8.

FIG. 9 is a side elevation view, in section, of the bladder of FIG. 8 showing a bonding step in constructing the first embodiment of bladder.

FIG. 9A is a top plan view FIG. 9.

FIG. 10 is a side elevation view of the first embodiment of bladder.

FIG. 11 is a side elevation view, in section, of the bladder of FIG. 5, showing a step in constructing a second embodiment of bladder having an end of a bladder 10 finished using a spacer.

FIG. 11A is a top plan view FIG. 11.

FIG. 12 is a side elevation view, in section, of the bladder of FIG. 11 showing a first folding step in constructing the second embodiment of bladder.

FIG. 12A is a top plan view FIG. 12.

FIG. 13 is a side elevation view, in section, of the bladder of FIG. 11 showing a second folding step in constructing the second embodiment of bladder.

FIG. 13A is a top plan view FIG. 13.

FIG. 14 is a side elevation view, in section, of the bladder of FIG. 13 showing a gluing step in constructing the second embodiment of bladder.

FIG. 14A is a top plan view FIG. 14.

FIG. 15 is a side elevation view, in section, of the bladder of FIG. 5, showing a step in constructing a third embodiment of bladder having an end of a bladder finished using a welded seam.

FIG. 15A is a top plan view FIG. 15.

FIG. 16 is a side elevation view, in section, of the bladder of FIG. 15 showing a positioning of a fold line in constructing the third embodiment of bladder.

FIG. 16A is a top plan view FIG. 16.

FIG. 17 is a side elevation view, in section, of the bladder of FIG. 16 showing a folding step in constructing the third embodiment of bladder.

FIG. 17A is a top plan view FIG. 17.

FIG. 18 is a side elevation view, in section, of the bladder of FIG. 17 showing a securing with a tape fastener in constructing the third embodiment of bladder.

FIG. 18A is a top plan view FIG. 18.

FIG. 19 is a side elevation view of a variation on the third embodiment finished using a welded seam, by rolling the ends of the bladder.

FIG. 20 is a side elevation view of a variation on the third embodiment finished using a welded seam, by using an accordion fold at the ends of the bladder.

FIG. 21 is a side elevation view of a variation on the third embodiment finished using a welded seam, by tying the ends of the bladder into a knot.

FIG. 22 is a side elevation view of a variation on the third embodiment finished using a welded seam, by tying the welded seam into a knot.

FIG. 23 is a side elevation view of a variation on the third embodiment finished using a welded seam, by using twisting and securing the ends of the bladder.

FIG. 24 is a side elevation view of a variation on the third embodiment finished using a welded seam, bunching the ends of the bladder.

### DETAILED DESCRIPTION

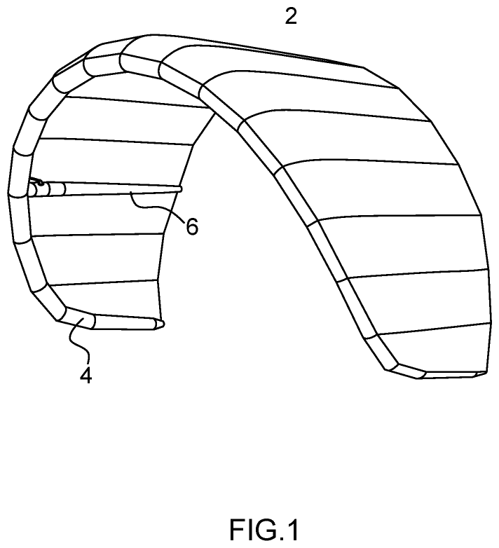

A method of sealing an airtight bladder for a kite will now be described with reference to FIG. 1 through FIG. 24.

Structure and Relationship of Parts:

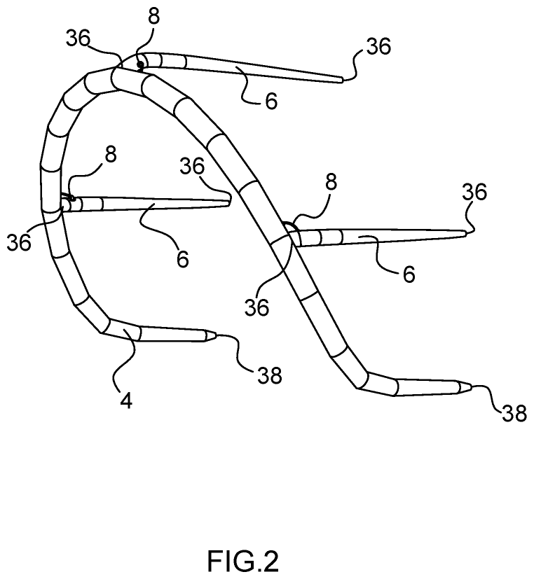

Referring to FIG. 1, there is illustrated an inflatable kite 2 used for kiting traction sports. Referring to FIG. 2, the support structure of kite 2 is shown with leading edge 4, struts 6 and valves 8 that inflate the bladders inside the leading edge 4 and struts 6. The struts 6 have strut ends 36 and the leading edge tube has leading edge tube ends 38.

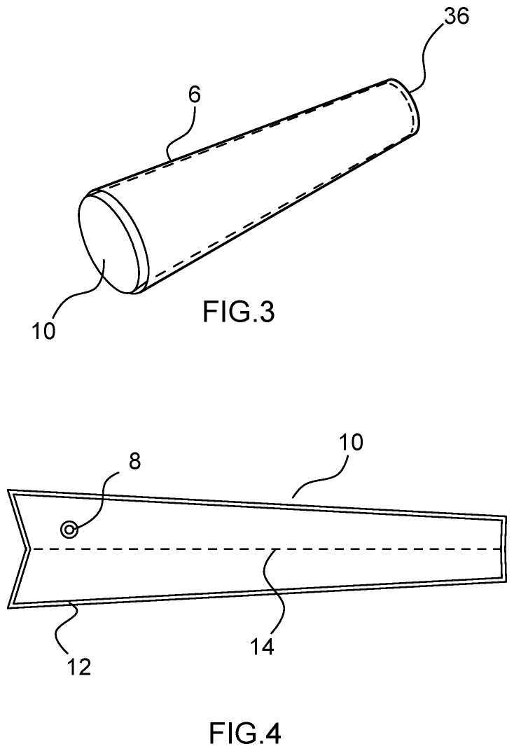

Referring to FIG. 3, there is illustrated how the bladder 10 fits inside of the strut 6 with the bladder end is against the strut end 36. Referring to FIG. 4, there is shown a view with an unassembled bladder 10 lying flat. Valve 8 is affixed to the bladder 10 near one end. A seam allowance 12 borders the edges of the bladder material 10. A fold line 14 extends along the lengthwise midline of bladder material 10.

We have reached the conclusion that the reason for the failures of SLE kite bladders is directly related to the quality of the weld. When a bladder with a welded plain seam is pressurized, the resulting force on the seam causes a stress concentration at the juncture of the films. Under pressure this stress concentration tears apart the bladders halves which propagates the stress concentration through the entirety weld eventually resulting in a failure.

We attempted to address the problem with laminated films. Laminated films provide advantages in bladder construction as stronger films can be combined with those which have favourable heat sealing properties or other various properties. Unfortunately, plain seams limit the use of laminated films in bladder construction as the glues used to bond multiple layers of film are particularly susceptible to delamination under this type of loading. In addition to the stress concentration created when loading a plain seam the geometry of this bladder construction method is such that the glued layers of the lamination are pulled directly apart where the adhesion strength is significantly less than that of the shear direction.

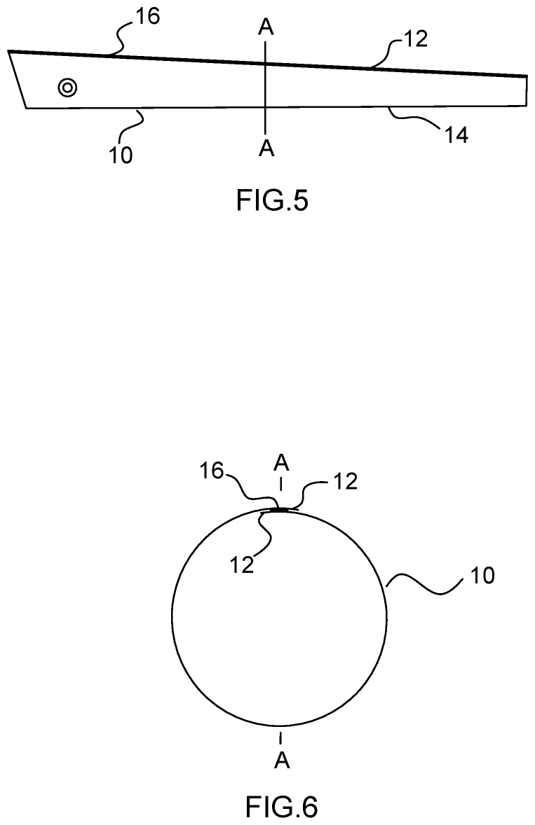

Referring to FIG. 5, the preferred method involves folding bladder material in half along fold line 14 and the seam allowances 12 have been over lapped and bonded with a welded lap seam 16 to form bladder 10. Referring to FIG. 6, this section view shows the partially assembled bladder 10 of FIG. 5 with seam allowances 12 over lapped and bonded with a welded lap seam 16.

Typically air holding bladders are designed to be the same size or slightly larger than the outer strut and spar envelope they are inflating. During a perfect inflation, the bladder will fill the entire void of the leading edge tube and strut envelopes, with the outer envelopes restraining the pressurized forces rather than the fragile bladder material taking any high pressure loads. The most common fail point in air holding bladders is at the end or tip of the inflated leading edge tube or strut. For if a bladder is not correctly fitted before inflation, the bladder film can be overstressed, in particular if the end does not come in contact with the ends of the outer envelope during the inflation process. This typically results in the aneurysm and failure of the film at the leading edge or strut end. This is undesirable as the SLE Kite will now deflate, losing its aerodynamic shape, making the kite uncontrollable while in use. Unfortunately, the geometry of a bladder with a welded longitudinal lap seam makes a regular lap seam on bladder ends impossible which create a weak point. For this reason, having welded lap seam 16 alone is not sufficient unless an effort is made to reinforce the ends. There will now be described some approaches that have been developed to reinforce the ends.

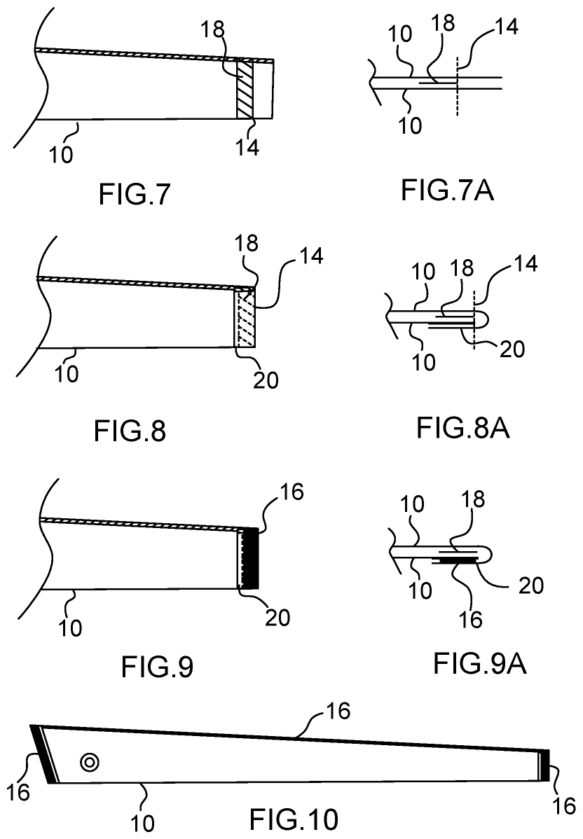

FIG. 7 through FIG. 10 show steps in constructing a first embodiment of bladder 10 with reinforced ends. Referring to FIG. 7, a spacer material 18, that doesn't bond to the bladder material 10, is inserted between the layers of the bladder 10. There is a fold line 14 at the edge of the spacer material 18. Referring to FIG. 7A, this figure provides a top plan view of spacer material 18 with fold line 14 at the edge of the spacer material 18. Referring to FIG. 8, there is shown a folding step with bladder 10 being folded along fold line 14 such that folded bladder 20 lays over spacer material 18. Referring to FIG. 8A, this figures provides a top plan view of bladder 10 folded along fold line 14 such that folded bladder 20 lays over spacer material 18. Referring to FIG. 9, there is shown a bonding step with folded bladder 20 being bonded to bladder 10 with a welded lap seam 16. Referring to FIG. 9A, this top plan view shows folded bladder 20 being bonded to bladder 10 with a welded lap seam 16. Spacer material 18 prevents the internal surfaces of bladder 10 from bonding together. Referring to FIG. 10, the first embodiment of bladder 10 is shown completed with welded lap seams 16 along the ends and lengthwise edge.

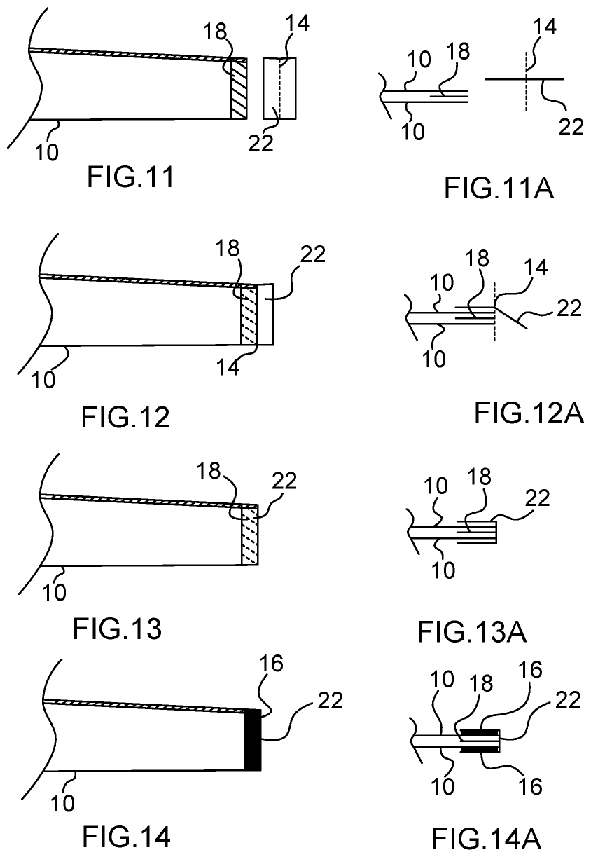

FIG. 11 through FIG. 14 show steps in constructing a second embodiment of bladder 10 with reinforced ends. Referring to FIG. 11, a spacer material 18, that doesn't bond to the bladder material 10, is inserted between the layers of the bladder 10. A separate bladder end piece 22 has a fold line 14. Referring to FIG. 11A, this top plan view shows spacer material 18, bladder end piece 22 and fold line 14. Referring to FIG. 12, the bladder end piece 22 positioned on one side of the end of bladder 10 in line with spacer material 18. Referring to FIG. 12A, this top plan view shows the bladder end piece 22 positioned on one side of the end of bladder 10, in line with spacer material 18, such that the fold line 14 is in line with the end of the bladder 10. Referring to FIG. 13, bladder end piece 22 is folded over the end of the bladder 10 such that both ends of the bladder end piece cover the spacer material 18. Referring to FIG. 13A this top plan view shows the bladder end piece 22 folded over the end of the bladder 10 such that both ends of the bladder end piece cover the spacer material 18. Referring to FIG. 14, the bladder end piece 22 is folded over the end of the bladder 10 and then bonded in place with a welded lap seam 16. Referring to FIG. 14A, this top plan view shows the bladder end piece 22 folded over the end of the bladder 10 and then bonded in place with a welded lap seam 16. Spacer material 18 prevents the internal surfaces of bladder 10 from bonding together.

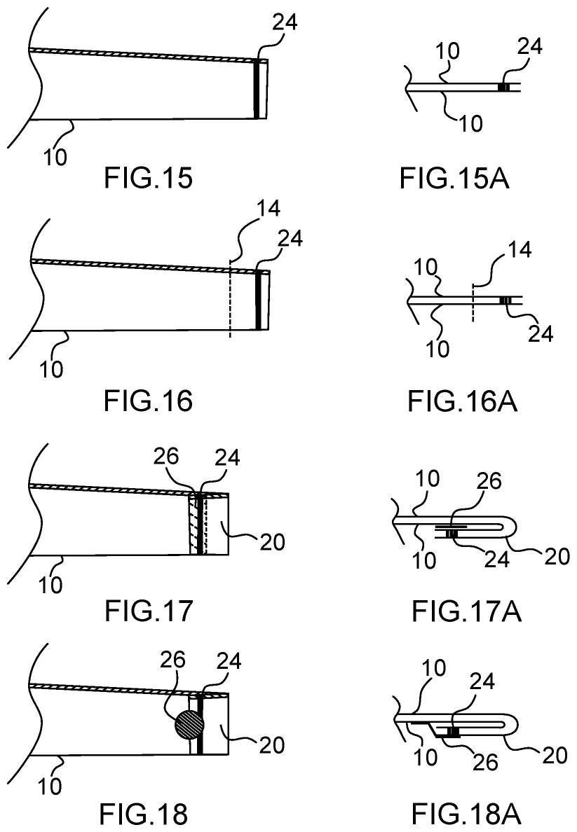

FIG. 15 through FIG. 18 show steps in constructing a third embodiment of bladder 10 with reinforced ends. Referring to FIG. 15, bladder 10 has a welded plain seam 24 near the end. Referring to 15A, this top plan view shows bladder 10 has a welded plain seam 24 near the end. Referring to FIG. 16, bladder 10 has a welded plain seam 24 near the end and a fold line 14. Referring to FIG. 16A, this top plan view shows bladder 10 with a welded plain seam 24 near the end and a fold line 14. Referring to FIG. 17, bladder 10 with a welded plain seam 24 is folded over 20 and then the folded bladder 20 is affixed to the bladder 10 with tape 26 between the folded bladder 20 and bladder 10. Referring to FIG. 17A, this top plan view shows bladder 10 with a welded plain seam 24 folded over 20 and then the folded bladder 20 is affixed to the bladder 10 with tape 26 between the folded bladder 20 and bladder 10. Referring to FIG. 18, bladder 10 with welded plain seam 24 is folded over 20 and then the folded bladder 20 is affixed to the bladder 10 with tape 26 on the outside of folded bladder 20 and bladder 10. Referring to FIG. 18A, this top plan view shows bladder 10 with welded plain seam 24 folded over 20 and then the folded bladder 20 is affixed to the bladder 10 with tape 26 on the outside of folded bladder 20 and bladder 10.

### Variations:

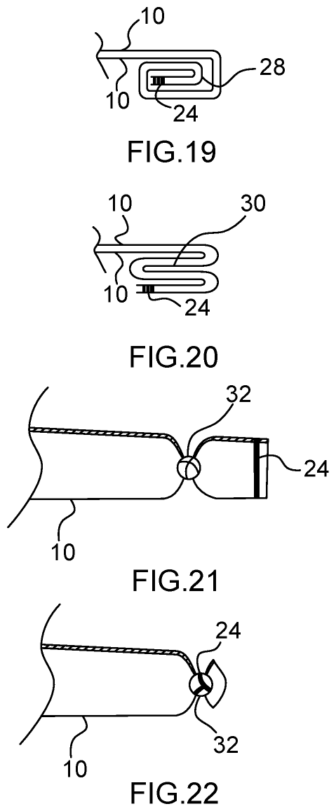

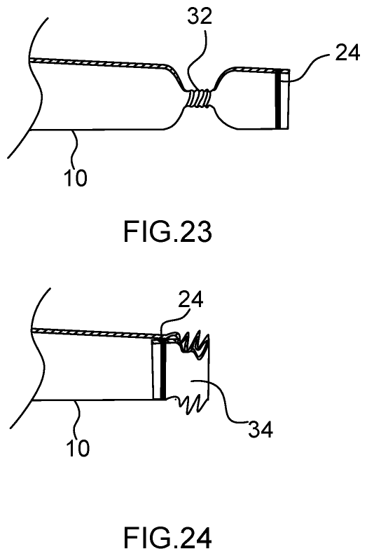

There are different manners of folding and securing the ends. A few of which will hereinafter be described. Referring to FIG. 19, the third embodiment of bladder 10 with a welded plain seam 24 could be rolled or have multiple folds 28. Referring to FIG. 20, the third embodiment of bladder 10 with a welded plain seam 24 could have an accordion fold 30. Referring to FIG. 21, the third embodiment of bladder 10 with a welded plain seam 24 could have bladder 10 tied in a knot 32. Referring to FIG. 22, the third embodiment of bladder 10 could have that section of the bladder 10 that has the welded plain seam 24 tied in a knot 32. Referring to FIG. 23, the third embodiment of bladder 10 with a welded plain seam 24 could be secured with twists 32. Referring to FIG. 24, the third embodiment of bladder 10 with a welded plain seam 24 could be secured with the end bunched 34.

### Operation:

Referring to FIG. 7 through 10, the airtight bladder for kites resulting from following the teachings of the method has a bladder body 10 having longitudinal edges sealed with a lap seam and ends sealed by a combination of deforming bladder material and applying an end seam. There has been illustrated the various ways that the bladder material may be deformed to shelter and protect the end seal. They include folding, rolling, accordion folding, knotting, or twisting the ends.

When in use bladder 10 is inserted into the protective soft envelope of the struts or leading edge. During inflation the ends are forced onto an inner surface of the protective soft envelope by the inflating bladder. However, this force holds the plain seam of the end in its folded configuration which prevents the film from opening under pressure and creating a stress concentration at the seam.

In the event of a high impact crash on an inflated SLE kite, impact forces typically move outward toward the tips of the leading edge, spars and struts, resulting in ruptures at the ends of the air tight bladder. By deforming the ends of the air tight bladder by folding, rolling, accordion folding, knotting, or twisting as described above, the chance of bladder failure is reduced.

This approach allows the use of lighter films, less than 70 microns and other light air holding laminated materials. The primary seam failure points, at the ends of the bladders, are enhanced by folding, rolling, accordion folding, knotting, or twisting. These deformations serve to help absorb pressure on the end.

Folding, rolling, accordion folding, knotting, or twisting, enables the ends to hold more pressure, with lighter films, allowing for higher PSI levels for SLE kites while reducing weights. Higher pressure leading edges, spars and struts deliver improved performance to the user. Light weight is always desirable on SLE Kites for improved handling and performance in all conditions.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the claims should not be limited by the illustrated embodiments set forth as examples, but should be given the broadest interpretation consistent with a purposive construction of the claims in view of the description as a whole.

What is claimed is:

1. A method of sealing an airtight bladder for kites, comprising:
sealing longitudinal edges of an airtight bladder with a lap seam; and
sealing ends of the bladder by both deforming bladder material and applying an end seam.

2. The method of claim 1, wherein the ends of the bladder are deformed by folding bladder material from the bladder back onto the bladder and sealing the folded bladder material to the bladder with a lap seam.

3. The method of claim 2, wherein a spacer material is inserted into the ends of the bladder, the spacer preventing the lap seam from bonding to the interior of the bladder.

4. The method of claim 1, wherein the ends of the bladder are sealed by covering the ends with a separate piece of bladder material deformed by folding and sealing the folded piece of bladder material to the bladder with a lap seam.

5. The method of claim 4, wherein a spacer material is inserted into the ends of the bladder, the spacer preventing the lap seam from bonding to the interior of the bladder.

6. The method of claim 1, wherein the ends of the bladder are sealed with a plain seam, the ends sealed with the plain seam are then deformed by folding back onto the bladder and held in place with a piece of tape between the folded section of bladder and the bladder.

7. The method of claim 1, wherein the ends of the bladder are sealed with a plain seam, ends sealed with the plain seam are then deformed by folding back onto the bladder and held in place with a piece of tape overlapping the folded section of bladder and the bladder.

8. The method of claim 1, wherein the ends of the bladder are sealed with a plain seam, the bladder material at the ends that are sealed with the plain seam is then deformed by folding back more than once onto the bladder and held in place with a piece of tape overlapping the folded section of bladder and the bladder.

9. The method of claim 1, wherein the ends of the bladder are sealed with a plain seam, the bladder material at the ends that are sealed with the plain seam are then deformed by being accordion folded back more than once onto the bladder and held in place with a piece of tape overlapping the folded section of bladder and the bladder.

10. The method of claim 1, wherein the ends of the bladder are sealed with a plain seam, the bladder material is then deformed by a knot tied into the bladder ahead of the plain seam.

11. The method of claim 1, wherein the ends of the bladder are sealed with a plain seam, the bladder material is then deformed by a knot tied into the section of bladder that has the plain seam.

12. The method of claim 1, wherein the ends of the bladder are sealed with a plain seam, the bladder material is then deformed in the area of the plain seam is by being folded back over top of the bladder material and held in place by glue.

13. The method of claim 1, wherein the ends of the bladder are sealed with a plain seam, the bladder material is then deformed by placing a series of twists into the bladder ahead of the plain seam.

14. The method of claim 1, wherein the ends of the bladder are sealed with a plain seam, the bladder material is then deformed by taking the end that is sealed with the plain seam and folding the end onto the bladder and the folded section is bunched together.

15. The method of claim 1, wherein the lap seam is made by welding.

16. An airtight bladder for kites, comprising:
A body having longitudinal edges sealed with a lap seam and ends sealed by a combination of deforming bladder material and applying an end seam.
